(19) United States
(12) Patent Application Publication
(10) Pub. No.: US 2026/0208689 A1
(43) Pub. Date: Jul. 23, 2026

(54) SEATBELT DEVICE FOR PILLARLESS VEHICLE AND PILLARLESS VEHICLE

(71) Applicant: Toyota Jidosha Kabushiki Kaisha, Toyota-shi (JP)

(72) Inventors: Mitsuyoshi OHNO, Miyoshi-shi (JP); Katsuya Shimazu, Toyota-shi (JP)

(73) Assignee: Toyota Jidosha Kabushiki Kaisha, Toyota-shi (JP)

(21) Appl. No.: 19/386,171

(22) Filed: Nov. 11, 2025

(30) Foreign Application Priority Data
Jan. 17, 2025 (JP) 2025-007012

(51) Int. Cl. B60R 22/24; B60R 22/02; B60R 22/18; B60R 22/48

(52) U.S. Cl. CPC B60R 22/24; B60R 22/02; B60R 22/48; B60R 2022/021; B60R 2022/1806; B60R 2022/4816; B60R 2022/4866; B60R 2022/4891

(57) ABSTRACT

A seatbelt device for a pillarless vehicle is provided, the seatbelt device including a shoulder anchor of which an upper portion is turnably attached to a roof rail and that also includes a buckle at a lower portion, a seatbelt including a tongue that is detachably attachable to the buckle, and a turning restriction member that links the shoulder anchor and a portion of a roof rail that is rearward of the upper portion of the shoulder anchor in a vehicle front-rear direction.

### CROSS-REFERENCE TO RELATED APPLICATION

This application claims priority to Japanese Patent Application No. 2025-007012 filed on Jan. 17, 2025. The disclosure of the above-identified application, including the specification, drawings, and claims, is incorporated by reference herein in its entirety.

### BACKGROUND

### 1. Technical Field

The present disclosure relates to a seatbelt device for a pillarless vehicle, and to a pillarless vehicle.

### 2. Description of Related Art

A seatbelt device in which, in a center pillarless vehicle, an upper part of a shoulder anchor with a buckle that is provided at a lower part thereof is turnably attached to a roof rail, a retractor and a lap anchor are attached to a floor panel at a lower position from a door opening portion side, a separation tongue that is inserted onto a seatbelt is detachably attachable to the buckle of the shoulder anchor, and also an attachment tongue inserted onto the seatbelt is detachably attachable to a buckle on a middle side of a vehicle cabin, has been conventionally known (e.g., see Japanese Unexamined Patent Application Publication No. 59-034958 (JP 59-034958 A)).

Also, in a center pillarless vehicle, a seatbelt structure in which a retractor and a lap anchor are provided on a floor panel below a door, and a shoulder anchor that slidably supports the seatbelt that is paid out from the retractor is provided on the roof rail above the door, is also conventionally known (e.g., see Japanese Unexamined Patent Application Publication No. 2003-011779 (JP 2003-011779 A)).

### SUMMARY

However, with the above-described configuration, there is a concern that in the event of a frontal collision of a center pillarless vehicle, the shoulder anchor may turn excessively toward a vehicle forward side, which may result in reduction in occupant restraining force that is provided by the seatbelt. As described above, there is still room for improvement in the structure for suppressing decrease in occupant restraining force provided by the seatbelt in an event of a frontal collision of a center pillarless vehicle.

Accordingly, an object of the present disclosure is to provide a seatbelt device that can suppress decrease in occupant restraining force of a seatbelt in the event of a frontal collision of a pillarless vehicle, and a pillarless vehicle that is equipped with the same.

In order to achieve the above-mentioned object, a seatbelt device for a pillarless vehicle according to a first aspect of the present disclosure includes a shoulder anchor of which an upper portion is turnably attached to a roof rail, and that also includes a buckle at a lower portion, a seatbelt including a tongue that is detachably attachable to the buckle, and a turning restriction member that links the shoulder anchor and a portion of a roof rail that is rearward of the upper portion of the shoulder anchor in a vehicle front-rear direction.

According to the first aspect of the disclosure, the upper portion of the shoulder anchor having the buckle at the lower portion is turnably attached to the roof rail, and the seatbelt has the tongue that is detachably attachable to the buckle. The portion of the roof rail that is rearward of the upper portion of the shoulder anchor in the vehicle front-rear direction is linked to the shoulder anchor by the turning restriction member. Accordingly, in the event of a frontal collision of the pillarless vehicle, the turning of the shoulder anchor is restricted by the turning restriction member. That is to say, movement of the seatbelt toward the vehicle forward side is restricted by the turning restriction member. Thus, decrease in the occupant restraint force of the seatbelt is suppressed.

Also, with the seatbelt device according to a second aspect of the present disclosure, in the seatbelt device according to the first aspect, the shoulder anchor is configured to transition from a stored state along the roof rail to a deployed state of being turned downward in a vehicle up-down direction in conjunction with closing of a side door or seating of an occupant, and to transition from the deployed state to the stored state in conjunction with release of the tongue from the buckle.

According to the second aspect of the disclosure, in conjunction with the closing of the side door or the seating of an occupant, the shoulder anchor transitions from a stored state along the roof rail to a deployed state of being turned downward in a vehicle up-down direction. Then, in conjunction with the release of the tongue from the buckle, the shoulder anchor transitions from the deployed state to the stored state. Therefore, the tongue can be easily attached to and detached from the buckle of the shoulder anchor while ensuring visual appeal of the vehicle cabin and ease of entering and exiting the pillarless vehicle (vehicle seat).

Also, with the seatbelt device according to a third aspect of the present disclosure, in the pillarless vehicle seatbelt device according to the first or second aspect, the shoulder anchor is configured to transition from a stored state along the roof rail to a deployed state of being turned downward in a vehicle up-down direction, in which an angle of turning downward in the vehicle up-down direction is adjusted in accordance with a front-rear position of a seat cushion of a vehicle seat and a rearward tilt angle of a seat back.

According to the third aspect of the disclosure, the shoulder anchor is configured to be capable of transitioning from the stored state along the roof rail to the deployed state of being turned downward in the vehicle up-down direction. The turning angle of the shoulder anchor downward in the vehicle up-down direction is adjusted in accordance with the front-rear position of the seat cushion of the vehicle seat and the rearward tilt angle of the seat back. Accordingly, occupant restraint performance that is appropriate for the front-rear position of the seat cushion and the rearward tilt angle of the seat back of the vehicle seat is ensured.

Also, with the seatbelt device according to a fourth aspect of the present disclosure, in the seatbelt device according to any one of the first to third aspects, the shoulder anchor is configured such that a length of the shoulder anchor is changeable.

According to the fourth aspect of the disclosure, the length of the shoulder anchor is changeable. Accordingly, not only is occupant restraint performance that is appropriate for the rearward tilt angle of the seat back ensured, but also occupant restraint performance that is appropriate for small occupants is ensured, as compared to a case in which the length of the shoulder anchor is not configured to be changeable (length of shoulder anchor cannot be increased).

Also, a pillarless vehicle according to a fifth aspect of the present disclosure includes the seatbelt device according to any one of the first to fourth aspects, and the pillarless vehicle is configured such that in a state in which the tongue is not attached to the buckle, when a gearshift position is shifted to D range or when a vehicle speed reaches or exceeds a predetermined speed, one of emitting a warning sound, limiting a maximum speed, and limiting acceleration, is executed, or such that the shifting into D range becomes unavailable in a state in which the tongue is not attached to the buckle.

According to the fifth aspect, when the gearshift position is shifted to D range or when the vehicle speed reaches or exceeds a predetermined speed, in a state in which the tongue is not attached to the buckle, one of emitting a warning sound, limiting the maximum speed, or limiting the acceleration, is executed, or shifting into D range is unavailable in a state in which the tongue is not attached to the buckle. Accordingly, an occupant that is seated in a vehicle seat can be prompted to fasten the seatbelt.

As described above, according to the present disclosure, decrease in the occupant restraining force of a seatbelt in the event of a frontal collision of a pillarless vehicle can be suppressed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic side view schematically illustrating a seatbelt device and a pillarless vehicle according to an embodiment;

FIG. 2 is an enlarged schematic side view of a shoulder anchor of the seatbelt device according to the embodiment;

FIG. 3 is an enlarged schematic side view illustrating the shoulder anchor according to the embodiment in a state before a frontal collision;

FIG. 4 is an enlarged schematic side view illustrating the shoulder anchor according to the embodiment in a state during a frontal collision; and

FIG. 5 is an enlarged schematic side view illustrating a modification of the shoulder anchor according to the embodiment.

### DETAILED DESCRIPTION OF EMBODIMENTS

An embodiment according to the present disclosure will be described below in detail with reference to the drawings. For the sake of convenience in description, an arrow UP in the drawings indicates an upward direction of a vehicle, and an arrow FR indicates a forward direction of the vehicle, as appropriate. In addition, in the following description, when directions such as up-down, front-rear, and right-left are mentioned without any other statement made in particular, these refer to up-down, front-rear, and right-left directions of a pillarless vehicle. Also, the right-left direction is synonymous with a vehicle width direction and a seat width direction.

Further, the vehicle according to the present embodiment is a pillarless vehicle (center pillarless vehicle) 10 in which at least one of center pillars (B pillars) on either the right or left side has been removed. However, in the drawings, a center pillar CP is intentionally illustrated by imaginary lines, to facilitate understanding of positions of a vehicle seat 12 and a seatbelt device 30 (shoulder anchor 40 described later) according to the present embodiment.

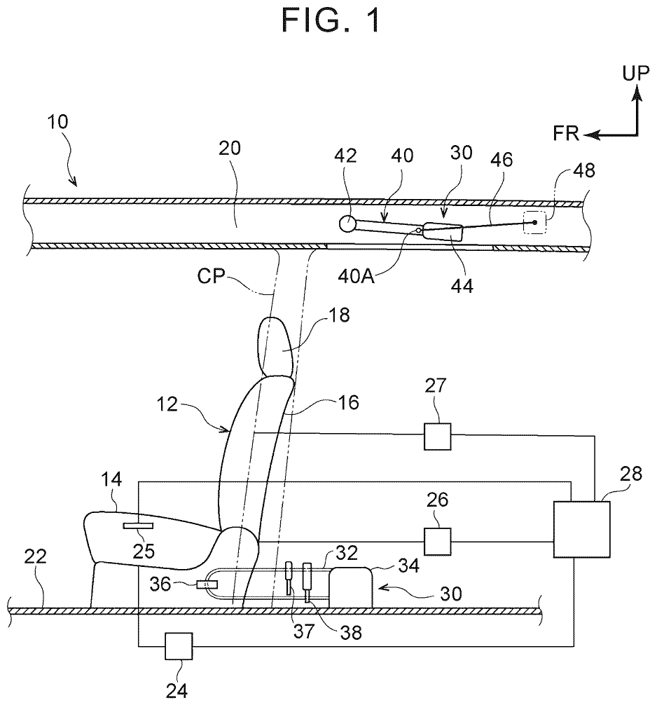

As illustrated in FIG. 1, the vehicle seat 12 is provided on a floor 22 of the pillarless vehicle 10. The vehicle seat 12 has a seat cushion 14, a seat back 16 that is turnable (tiltable backward and forward) with the seat width direction as an axial direction at a rear end portion of the seat cushion 14, and a headrest 18 that is movable up and down in a center portion of the seat width direction at an upper end of the seat back 16.

Note that the vehicle seat 12 is supported so as to be slidable in the front-rear direction on a slide rail (omitted from illustration) or the like that is provided on the floor 22, and a position of the seat cushion 14 is detected by a position detection device 24 such as a position sensor or the like. Also, the vehicle seat 12 is also provided with an angle detection device 26 such as an angle sensor or the like, which detects a rearward tilt angle of the seat back 16.

Also, the vehicle seat 12 is provided with a seating detection device 25 that detects when an occupant (omitted from illustration) is seated on the seat cushion 14, and the pillarless vehicle 10 is provided with a closure detection device 27 that detects when a side door that is omitted from illustration is closed. The pillarless vehicle 10 is provided with a control device 28, and the position detection device 24, the seating detection device 25, the angle detection device 26, and the closure detection device 27 are each electrically connected to the control device 28.

Also, a retractor 34 is provided on the floor 22 on a side door side (vehicle-width direction outer side) and biases a seatbelt 32 in a winding direction to accommodate the seatbelt. A lap outer anchor 36, through which the seatbelt 32 that is paid out from the retractor 34 is passed, is provided on a side portion of the vehicle seat 12, on the vehicle-width direction outer side thereof. The seatbelt 32 that is paid out from the retractor 34 is movably provided with a shoulder-side tongue 38 and a lap-side tongue 37 as tongues thereon.

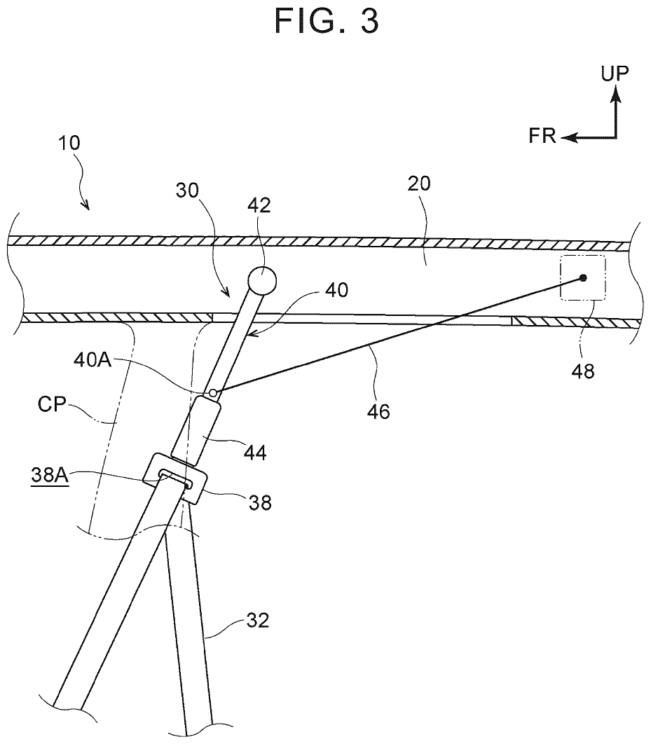

That is to say, one end of the seatbelt 32 is attached to a winding reel (omitted from illustration) of the retractor 34, and the one end side is biased in the winding direction to be wound up. The other end of the seatbelt 32 that is paid out from the retractor 34 is sequentially passed through a passage slot 38A of the shoulder-side tongue 38 (see FIGS. 3 to 5) and a passage slot of a lap-side tongue 37 (omitted from illustration), and then passed through a passage slot of the lap outer anchor 36 omitted from illustration), folded back, and fixed at a predetermined position inside the retractor 34.

Thus, of the seatbelt 32 that is stretched between the retractor 34 and the lap outer anchor 36, the seatbelt 32 that is passed through the passage slot 38A of the shoulder-side tongue 38 and the passage slot of the lap-side tongue 37 is configured to be capable of being manually paid out from the retractor 34 against the biasing force, by an occupant that is seated in the vehicle seat 12. Note that a lap-side buckle (omitted from illustration), to which the lap-side tongue 37 is detachably attachable, is provided on the floor 22 at a side portion on an inner side in the vehicle width direction of the vehicle seat 12, or a position downward therefrom.

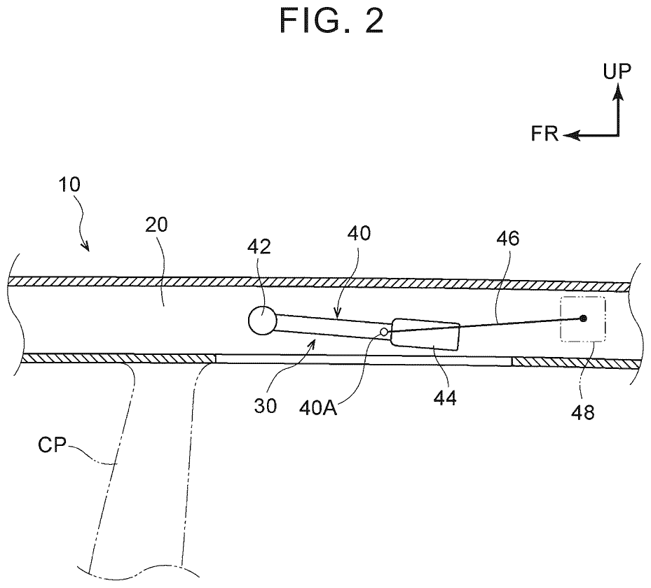

As illustrated in FIGS. 2 and 3, a shoulder anchor 40 is provided on a roof rail 20 of the pillarless vehicle 10. The shoulder anchor 40 is formed in the shape of an elongated plate of a predetermined thickness, and an upper portion (one end portion in longitudinal direction) thereof is turnably attached to a predetermined position of the roof rail 20.

Describing this in further detail, a turning shaft 42 that is post-like, of which the axial direction is in the vehicle width direction, is fixed to the upper portion of the shoulder anchor 40, and an electric motor (omitted from illustration) and a gear mechanism (omitted from illustration) for turning the turning shaft 42 are installed within the roof rail 20. Accordingly, the shoulder anchor 40 is turnable from a stored state along the roof rail 20 (see FIG. 2) to a deployed state that is turned downward (see FIG. 3), and from the deployed state that is turned downward to the stored state along the roof rail 20, by turning driving force of the electric motor in a forward direction and a reverse direction.

This electric motor is electrically connected to the control device 28. That is to say, this shoulder anchor 40 is configured to transition from the stored state along the roof rail 20 to the deployed state of being turned downwardly by the electric motor being driven to rotate in the forward direction under the control of the control device 28, in conjunction with detection of the closure of the side door by the closure detection device 27 or detection of an occupant being seated by the seating detection device 25.

Note that at this time, turning drive amount of the electric motor is configured to be adjusted under control of the control device 28 according to a front-rear position of the seat cushion 14 of the vehicle seat 12 and a rearward tilt angle of the seat back 16 (based on detection results of position detection device 24 and angle detection device 26). In other words, a configuration is made in which a downward turning angle of the shoulder anchor 40 (front-rear direction position of shoulder-side buckle 44, which will be described later) is adjustable.

A shoulder-side buckle 44, serving as a buckle, is provided at a lower portion (other end in longitudinal direction) of the shoulder anchor 40. The shoulder-side tongue 38 is configured to be detachably attachable to the shoulder-side buckle 44. A configuration is made in which attachment/detachment of the shoulder-side tongue 38 to and from the shoulder-side buckle 44 is detected by an attachment/detachment detection device (omitted from illustration), and the attachment/detachment detection device is also electrically connected to the control device 28.

That is to say, this shoulder anchor 40 is configured to transition from a deployed state of being downwardly turned to a stored state along the roof rail 20 by the electric motor being driven to turn in the reverse direction under control of the control device 28 in conjunction with the detection of detachment of the shoulder-side tongue 38 from the shoulder-side buckle 44 by the attachment/detachment detection device.

Also, a predetermined position on a portion of the roof rail 20 that is rearward of the upper portion (turning shaft 42) of the shoulder anchor 40 and a longitudinal midpoint portion 40A of the shoulder anchor 40 (portion near to shoulder-side buckle 44) are linked by a wire member (turning strength retaining wire) 46 which serves as a turning restriction member.

To describe this in further detail, a small-sized retractor 48 having the same function as the retractor 34 (function of locking sudden pay-out) is also built in at a predetermined position on the roof rail 20, and one end portion of the wire member 46 is attached to a winding reel (omitted from illustration) of the retractor 48, and also the one end side is biased in the winding direction of winding up.

An other end portion of the wire member 46 is attached to the longitudinal midpoint portion 40A of the shoulder anchor 40. Accordingly, a configuration is made in which excessive forward turning of the shoulder anchor 40 (shoulder-side buckle 44) in the event of a frontal collision of the pillarless vehicle 10 is limited by the wire member 46.

Thus, the seatbelt device 30 according to the present embodiment is configured to include the seatbelt 32, the retractor 34, the lap outer anchor 36, the lap-side tongue 37, the shoulder-side tongue 38, the lap-side buckle, the shoulder anchor 40 (turning shaft 42 and shoulder-side buckle 44), the electric motor, the gear mechanism, the wire member 46, the retractor 48, and so forth.

In addition, the pillarless vehicle 10 according to the present embodiment is provided with a warning sound generating device (omitted from illustration) that emits a warning sound for the occupants, and this warning sound generating device is also electrically connected to the control device 28. This pillarless vehicle 10 is configured such that when the attachment/detachment detection device detects a state in which the shoulder-side tongue 38 is not attached to the shoulder-side buckle 44, and the gearshift position is shifted into D range or the vehicle speed reaches or exceeds a predetermined vehicle speed, execution of one of emitting a warning sound, limiting the maximum speed, and limiting the acceleration will be carried out under control of the control device 28.

It should be noted that the pillarless vehicle 10 according to the present embodiment is not limited to the above configuration, and may be configured such that in a state in which the attachment/detachment detection device detects that the shoulder-side tongue 38 is not attached to the shoulder-side buckle 44, the control device 28 controls the vehicle to be unable to shift into D range.

Next, operations of the seatbelt device 30 and the pillarless vehicle 10 according to the present embodiment that is configured as above will be described.

As described above, the upper portion (turning shaft 42) of the shoulder anchor 40 having the shoulder-side buckle 44 at the lower portion thereof is turnably attached to the roof rail 20, and the seatbelt 32 has the shoulder-side tongue 38 that is detachably attachable to the shoulder-side buckle 44. The portion of the roof rail 20 that is rearward of the upper portion (turning shaft 42) of the shoulder anchor 40 and the longitudinal midpoint portion 40A of the shoulder anchor 40 are linked by the wire member 46.

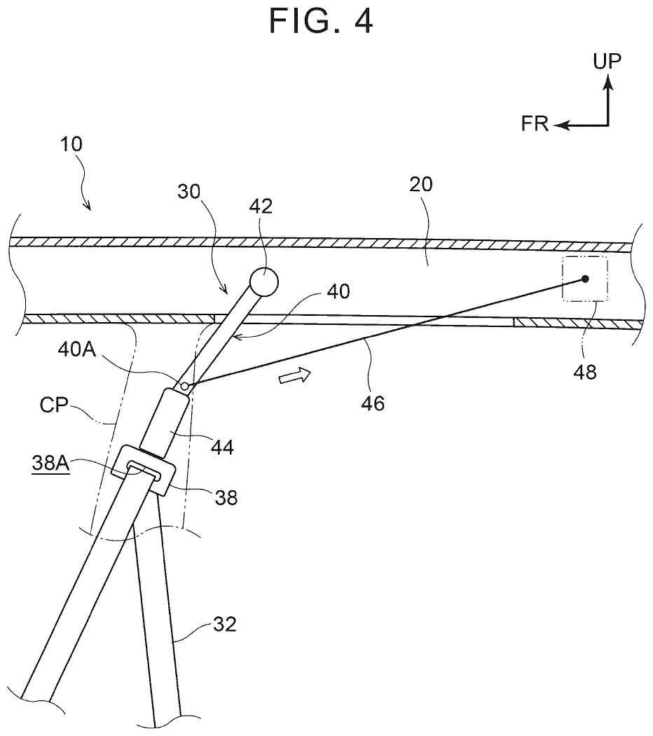

Accordingly, as illustrated in FIG. 4, in the event of a frontal collision of the pillarless vehicle 10, excessive forward turning of the shoulder anchor 40 (shoulder-side buckle 44) is restricted by the wire member 46. That is to say, forward movement of the seatbelt 32 is restricted by the wire member 46. This enables decrease in the occupant restraining force of the seatbelt 32 to be suppressed.

Moreover, the shoulder anchor 40 transitions from a stored state along the roof rail 20 to a deployed state of being turned downward in conjunction with the closing of the side door or the seating of an occupant. The shoulder anchor 40 then transitions from the deployed state to the stored state in conjunction with the release of the shoulder-side tongue 38 from the shoulder-side buckle 44. Accordingly, the shoulder-side tongue 38 can be easily attached to and detached from the shoulder-side buckle 44 of the shoulder anchor 40 while ensuring the visual appeal of the vehicle cabin and ease of entering and exiting the pillarless vehicle 10 (vehicle seat 12).

Also, when the shoulder anchor 40 transitions from the stored state along the roof rail 20 to the deployed state of being turned downward, the downward turning angle (front-rear position of shoulder-side buckle 44) is adjusted in accordance with the front-rear position of the seat cushion 14 of the vehicle seat 12 and the rearward tilt angle of the seat back 16. Accordingly, occupant restraint performance that is appropriate for the front-rear position of the seat cushion 14 of the vehicle seat 12 and the rearward tilt angle of the seat back 16 can be ensured.

Also, when this pillarless vehicle 10 is shifted into D range or when the vehicle speed reaches or exceeds a predetermined speed in a state in which the shoulder-side tongue 38 is not attached to the shoulder-side buckle 44, one of emitting a warning sound, limiting the maximum speed, and limiting acceleration, is executed, or alternatively, shifting into D range becomes unavailable as long as in a state in which the shoulder-side tongue 38 is not attached to the shoulder-side buckle 44. Therefore, an occupant that is seated in the vehicle seat 12 can be prompted to fasten the seatbelt 32.

In particular, with such a pillarless vehicle 10, it may become difficult to attach the shoulder-side tongue 38 to the shoulder-side buckle 44 once the vehicle has started to travel, and accordingly the above-described configuration is effective. It should be noted that the shoulder-side buckle 44 and so forth may be provided with a locking mechanism that incapacitates detachment of the shoulder-side tongue 38 from the shoulder-side buckle 44 while the pillarless vehicle 10 is traveling.

### Modifications

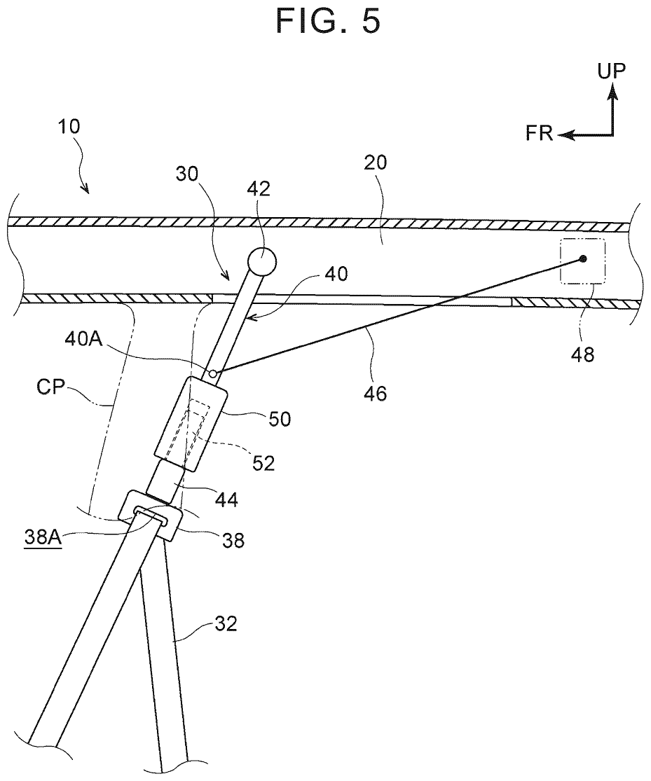

In closing, modifications of the shoulder anchor 40 will be described. As illustrated in FIG. 5, the shoulder anchor 40 may be configured such that the length thereof is variable. That is to say, a holder 50 and a protruding member 52 of which a protruding amount from the holder 50 is adjustable may be provided at the lower portion of the shoulder anchor 40, and also the shoulder-side buckle 44 may be provided at a distal end of the protruding member 52 on a protruding direction side.

According to such a configuration, not only the occupant restraint performance appropriate for the rearward tilt angle of the seat back 16, but also occupant restraint performance that is appropriate for small occupants, can be ensured as compared to a configuration in which the length of the shoulder anchor 40 is not adjustable (length of shoulder anchor 40 cannot be increased).

Note that the term “small occupant” referred to here is, for example, an occupant that is equivalent to AF05 (fifth percentile for American adult females), a dummy used in frontal collision tests. Also in this case, the other end of the wire member 46 may be attached to the longitudinal midpoint portion 40A of the shoulder anchor 40 (portion near to the holder 50).

While the seatbelt device 30 and the pillarless vehicle 10 according to present embodiment has been described so far based on the drawings, the seatbelt device 30 and the pillarless vehicle 10 according to the present embodiment are not limited to those illustrated in the drawings, and can be appropriately modified in design without departing from the spirit and scope of the present disclosure.

For example, the turning restriction member is not limited to a string-like member of which the wire member 46 is representative, and may be a band-like member having a predetermined width. Also, the shoulder anchor 40 may be configured to be manually turned from the stored state to the deployed state, and from the deployed state to the stored state. Also, the retractor 34 may be provided on the vehicle seat 12 instead of on the floor 22, and the lap outer anchor 36 may be provided on the floor 22 instead of on the vehicle seat 12.

Also, the seatbelt device 30 according to the present embodiment can be effectively applied not only to a vehicle seat 12 that is a normal forward-facing vehicle seat, but also to a rotating front seat (omitted from illustration) that can face rear seats and is provided in an autonomous vehicle or the like. Also, the seatbelt device 30 according to present embodiment can also be effectively applied to a rear seat (omitted from illustration) of a sliding door vehicle in which the center pillar CP has been removed.

What is claimed is:

1. A seatbelt device for a pillarless vehicle, the seatbelt device comprising:
a shoulder anchor of which an upper portion is turnably attached to a roof rail, and that also includes a buckle at a lower portion;
a seatbelt including a tongue that is detachably attachable to the buckle; and
a turning restriction member that links the shoulder anchor and a portion of a roof rail that is rearward of the upper portion of the shoulder anchor in a vehicle front-rear direction.

2. The seatbelt device according to claim 1, wherein the shoulder anchor is configured to transition from a stored state along the roof rail to a deployed state of being turned downward in a vehicle up-down direction in conjunction with closing of a side door or seating of an occupant, and to transition from the deployed state to the stored state in conjunction with release of the tongue from the buckle.

3. The seatbelt device according to claim 1, wherein the shoulder anchor is configured to transition from a stored state along the roof rail to a deployed state of being turned downward in a vehicle up-down direction, in which an angle of turning downward in the vehicle up-down direction is adjusted in accordance with a front-rear position of a seat cushion of a vehicle seat and a rearward tilt angle of a seat back.

4. The seatbelt device according to claim 1, wherein the shoulder anchor is configured such that a length of the shoulder anchor is changeable.

5. A pillarless vehicle comprising the seatbelt device according to claim 1, wherein the pillarless vehicle is configured such that in a state in which the tongue is not attached to the buckle, when a gearshift position is shifted to D range or when a vehicle speed reaches or exceeds a predetermined speed, one of emitting a warning sound, limiting a maximum speed, and limiting acceleration, is executed, or such that the shifting into D range becomes unavailable in a state in which the tongue is not attached to the buckle.
